(19) United States
(12) Patent Application Publication
(10) Pub. No.: US 2007/0101689 A1
(43) Pub. Date: May 10, 2007

(54) Vent protector device for exhaust vents of buildings

(76) Inventor: William Gaskins, Fort Washington, MD (US)

Correspondence Address: MARY HELEN SEARS;M.H. SEARS LAW FIRM, CHTD, 910 17th St., N.W., WASHINGTON, DC, 20006, US

(21) Appl. No.: 11/269,672

(22) Filed: Nov. 9, 2005

(51) Int. Cl. B01D 50/00

(52) U.S. Cl. 55/385.4

(57) ABSTRACT

Exhaust vent pipes of existing buildings often admit unwanted substances such as insects, dust, dirt, weather-derived moisture and airborne contaminants into the building when their exhaust function is not in use. A device for installation on such exhaust vent pipes to prevent this problem, in its simplest form comprises a pipe length of slightly larger circumference than the vent pipe, equipped at its upper end with a hinged cap and adapted at its lower end to fit over and partially jacket the upper end of the vent pipe and to be stably connected to that vent pipe. Preferably the upper end of the device is constructed so that the pipe opening is angled downward from an upper high point or fulcrum on its circumference where the hinge of the cap is attached, whereby the cap, when closed, slants downward from the hinge which may either bisect the cap or occupy one portion of the rim of a unitary cap. In either case, the preferred cap, when closed, slants downwardly from the hinge and slightly overlaps the rim of the pipe. The basic device may be equipped with a hood of substantially greater elevation and circumference, which not only affords greater protection to the building interior when the exhaust vent pipe is not exhausting vapors but also protects the exhaust vent from tampering by birds and small animals and from severe weather effects. Two hood embodiments are shown, both equipped with (i) backflow means to prevent exhausted vapors from reentry into the building and (ii) suitably placed perforations that ensure that exhausted vapors pass outward. For inclusion in buildings to be erected in the future, the device is made integral with the vent pipe by extending the length of the latter and finishing the upper end with a hinged cap, with or without added hood means.

### INTRODUCTION

The present invention relates to a device effective to shield the interior of a building from the ingress of dust, dirt, pathogenic substances, allergens, insects, moisture and other unwanted airborne substances which substances penetrate through the vent openings made for expelling odors, smoke, fumes, etc by the action of exhaust fans and other similar devices installed in buildings. that must be vented to the outside air.

### BACKGROUND OF THE INVENTION

Residential buildings, large and small, today have many vent openings to accommodate the need, e.g., for bathroom air exhaust fans, kitchen range exhaust hoods, attic exhaust fans and other similar devices. Need for installing similar exhaust devices in other types of buildings wherein people work or congregate for purposes of business, entertainment, physical workout, civic and educational pursuits, etc. has led to building codes that almost universally require vent pipes of some nature in virtually every type of building erected or rehabilitated for use today. Little, if any, attention has heretofore been paid to the fact that when vent pipes are not performing their venting purpose, they are open and they intake airborne substances, perhaps because the flow of outside air into an open vent pipe that has no air intake pump or other attached device for immediately replacing exhausted air is deemed negligible, given the many other ways in which air is able to access even the most carefully protected and well built buildings of all types.

The present invention was stimulated by the recognition that for any enclosed structure, open vent pipes are a source of unwanted dust and dirt, moisture, insects, and various irritative, infective and otherwise unwanted agents, followed by a fruitless search for a cost-effective device that is capable of eliminating the effects of leaving these vents open to outside air and unprotected at times when their venting function is not in use.

### BRIEF DESCRIPTION OF THE INVENTION

In its simplest form, the present invention consists essentially of a pipe length of slightly larger circumference than the vent pipe, topped by a hinged cover. The pipe length forms a jacket over the open end of the vent pipe and is equipped with a hinged cover at its top end, which cover is blown open by the force of exhausting gas but drops over the pipe length end when no venting is in progress, thereby capping off both the vent pipe and the pipe length jacketing the vent pipe from the external atmosphere. The combination of a pipe length of slightly larger circumference than the vent pipe, a hinged cap and, if needed, one or more set screws (used to assure a snug fit between the vent pipe and the slightly larger pipe length) is referred to hereinafter as a “vent protector”. The hinged cap may be fashioned so that its hinge bisects the cap into two half portions, or the hinge may be attached on the outer periphery of the cap.

The pipe section slightly larger than the vent pipe may be fashioned of heavy plastic or stainless steel or other non-rust metal. In the preferred embodiments of the vent protector, the upper end of the pipe length is cut or machined so that it is not level around its circumference, but when viewed from the side is slanted downwardly and the cap is fashioned to slightly overlap the edge of the open pipe all around the pipe circumference.

In more sophisticated embodiments the simplest forms of the vent protector device described above are equipped with a form of hood which is significantly larger than both the vent pipe and the vent protector. The hood includes means for venting gases to the atmosphere and acts to protect the vent pipe and its vent protector from insects, wind, snow, rain, and sleet. Whether or not hooded, the vent protector device also protects the vent pipe from birds and small animals, such as squirrels.

### BRIEF DESCRIPTION OF THE DRAWINGS

FIGS. 1A, 1B, 1C and 1D illustrate a basic vent protector device of this invention having a central hinged cover device. FIG. 1A is a perspective view of the device about to be lowered over an open vent pipe. FIG. 1B is a side view of the vent protector in closed position, while FIG. 1C is a front view of the same device. FIG. 1D is a close-up top view of the hinged protector cap in closed position.

FIG. 2A, 2B, 2C, and 2D illustrate another form of the basic vent protector wherein the protective device has a one-piece cover hinged at the uppermost point of the device. FIG. 2A is a perspective view of the vent protector positioned above the vent pipe and about to be lowered thereon. FIG. 2B is a side view of this vent protector and FIG. 2C is a front view of this device, while FIG. 2D is a top view of the same vent protector.

FIGS. 3A, 3B, and 3C show a hooded vent protector of the type shown in FIGS. 2A-2D inclusive. More particularly, FIG. 3A represents the side view of a vent pipe equipped with the vent protector of FIGS. 2A-2D over which an elongated bell shaped hood has been attached, with the vent protector cap in open position to discharge exhausted gases from a building interior. FIG. 3B is a view of the same hooded vent protector pipe with its vent protector cap in closed position and FIG. 3C shows the detail of the backflow plate to the hood which surrounds the vent protector at the base of the hood and acts both to permit outflow of effluent emanations from the vent pipe and also to screen out the ingress of foreign substances from the atmosphere. FIGS. 4A, 4B, and 4C depict a hooded variation of the vent pipe equipped with a vent protector as shown in FIGS. 2A-2D inclusive. FIG. 4A shows a side view of the protected vent pipe enclosed in a drain tube having a mesh of small holes around its periphery to allow draining of vented gases and equipped with a three-tier domed hood. FIG. 4B shows a front view of the same domed hood. FIG. 4C depicts a solid backflow plate encompassing the vent pipe and the vent protects or at the hood bottom.

### DETAILED DESCRIPTION OF THE INVENTION

The vent protector of the present invention may be fashioned in any number of shapes, sizes and dimensions. It may be fashioned of any weather resistant material, such as plastic or a non-rust metal such as stainless steel, tin or aluminum.

Basically, in its simplest form it consists of a length of pipe so sized in diameter as to fit over the open end of a vent pipe and, if needed, at least one set screw—and when needed up to 4 such screws—positioned near the lower end of the overfitted pipe length, where they may be tightened to ensure a snug and stable fit with the underlying vent pipe. Any other device capable of ensuring a tight and stable connection of the vent protector to the vent exhaust pipe may be used in place of one or more set screws.

The second necessary component, a hinged cap, is positioned at the vent protector's upper end to act as a cap for both the vent protector and the vent pipe during periods when air is not being exhausted from the vent pipe. When air is being exhausted through the vent pipe, the force of the exhaust pressure blows the cap open and allows escape of the air it is exhausting.

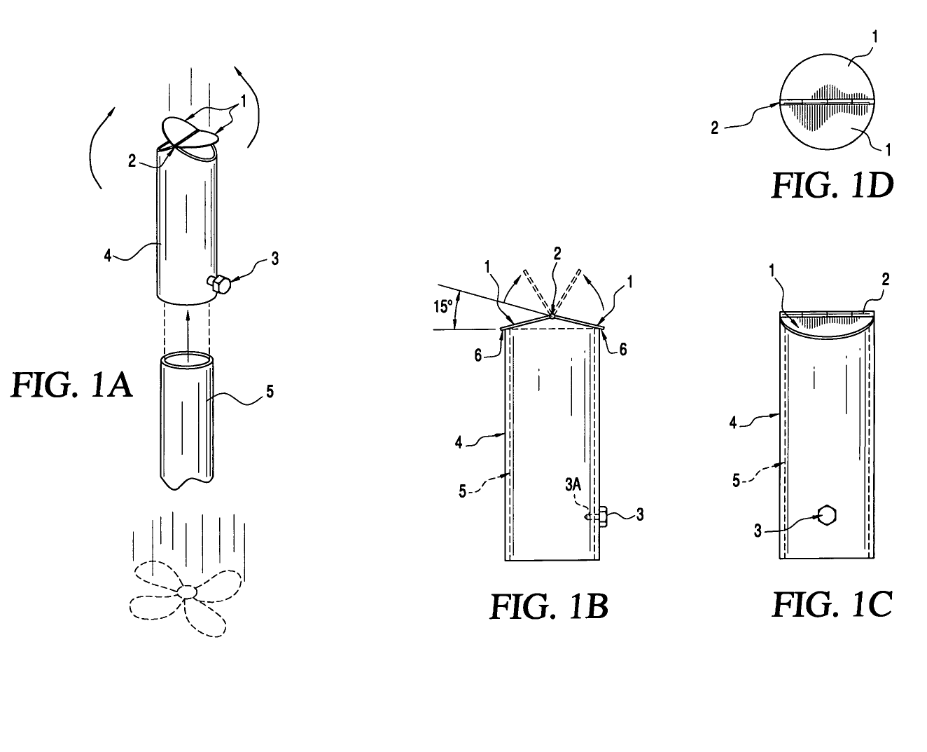

Two types of hinged caps for the upper end of the vent protector are illustrated in the drawings. In FIG. 1D, the cap is a flat circular one, bisected at its center by a hinge which allows both halves of the circular cap to be blown upward by the force of exhausting air. When closed, the halves of the cap preferably angle downwardly over circular downwardly extended cuts in the top of the protector pipe and slightly overlap the rim of the pipe. This construction feature, which is visible in the side view drawing 1B and the front view drawing 1C, as well as in the perspective drawing 1A wherein the vent protector is open and in position to exhaust air, is preferred because it affords better protection against tampering by animals or birds than a cap-conduit relationship wherein the conduit top is horizontally aligned around its periphery and the cap fits over it, in a horizontal relationship. The cap may be made of any relatively lightweight material, such as a durable lightweight plastic, a lightweight, non-rust, metal such as tin or aluminum, etc. The hinge and its pin are stainless steel or other rustproof durable material.

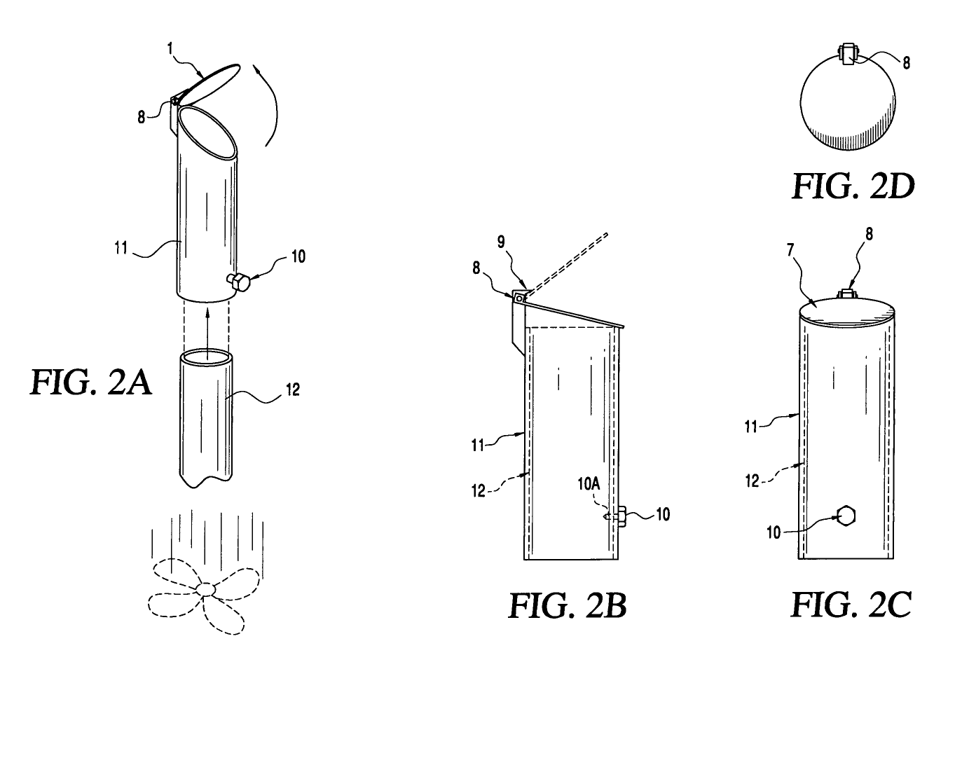

An alternative form of valve is depicted in FIG. 2D wherein the vent protector is fashioned with a top opening which is not horizontally aligned around its periphery, but rather, when viewed from the side, it is canted at an angle with the hinge of the cap mounted at the highest point, as is visible in the perspective drawing, FIG. 2A, and also in the side view, FIG. 2B. So positioned, the cap; when closed, rests at an angle and extends downwardly from the hinge to rest upon and slightly overlap the downwardly slanted rim of the vent protector. While this is a preferred construction of the vent protector when it is equipped with a hinge mounted on a part of the cap circumference, it is also within the scope of this invention to attach a hinged cap to an upper, flat, horizontally disposed, even rim of a vent protector. The vent protector top which is angled from an upper high point downward to an opposite lowest point on the upper periphery of the vent protector is preferred because it is less easily manipulatable from the exterior into an open position by birds and small animals, such as squirrels, etc. and it helps in encouraging rapid runoff of water, snow, etc. and preventing accumulation of such substances around.

Both types of cap are fashioned so that they overlap the rim of the vent protector pipe slightly when in closed position, and thereby provide protection from rain, snow, sleet, insects and wind-borne detritus so long as the vent protector pipe is in closed position, as well as encouraging runoff of moisture in all states.

FIGS. 1A-1D inclusive and 2A-2D inclusive, respectively, show the two preferred versions of the simplest form of the vent protector device of this invention. In each of FIGS. 1A, 1B, 1C, and 1D the integers 1 denote the two halves, or flaps of the vent protector cap, the integers 2 refer to the hinge which is equipped with a hinge pin, the integers 3 denote a set screw, and 3A refers to the tip of the set screw that extends into the partially enclosed vent (or “exhaust pipe”). Integers 4 identify the exterior of the vent protector pipe and integers 5 refer to the vent or exhaust pipe itself. In FIG. 1B the integers 6 refer to the overlap between the cap and outer wall of the vent protector pipe.

In each of FIGS. 2A, 2B, 2C, and 2D integers 7 refer to the unitary vent protector cap, integers 8 denote its hinge and hinge pin assembly, and integer 9 is a lid stop attached behind and extending above the hinge for the purpose of preventing the cap from extending so far backward when in open position that it does not immediately close when free of exhaust pressure from the vent pipe. Integers 10 represent a set screw in these drawings and 10A refers to the set screw tip which extends through and into the exhaust pipe. In these drawings 2A-2D inclusive, further, the integers 11 denote the outer wall of the vent protector pipe while integers 12 refer to the exhaust or vent pipe itself.

As will be readily understood, the preferred versions of the device depicted in FIGS. 1A-1D inclusive and FIGS. 2A-2D inclusive are particularly designed to be fitted over pre-existing vent pipes on a building. It is contemplated that vent protector pipes within the scope of this invention can readily be designed to mate with vent pipes such that both might be installed simultaneously in buildings under construction or to be constructed. Such prefitted vent pipe-vent protector combinations can, e.g. be provided with mated opposing threads that can be firmly screwed together and will act to hold the two pipes in snug, stable relationship in lieu of using set screws for that purpose. Alternatively, a single pipe properly equipped with a hinged cover may be installed to provide both venting and vent protection functions. Many other modifications can readily be made to afford both functions to an exhaust fan venting system without departing from the scope of this invention, as will be readily apparent to those of ordinary skill in the art.

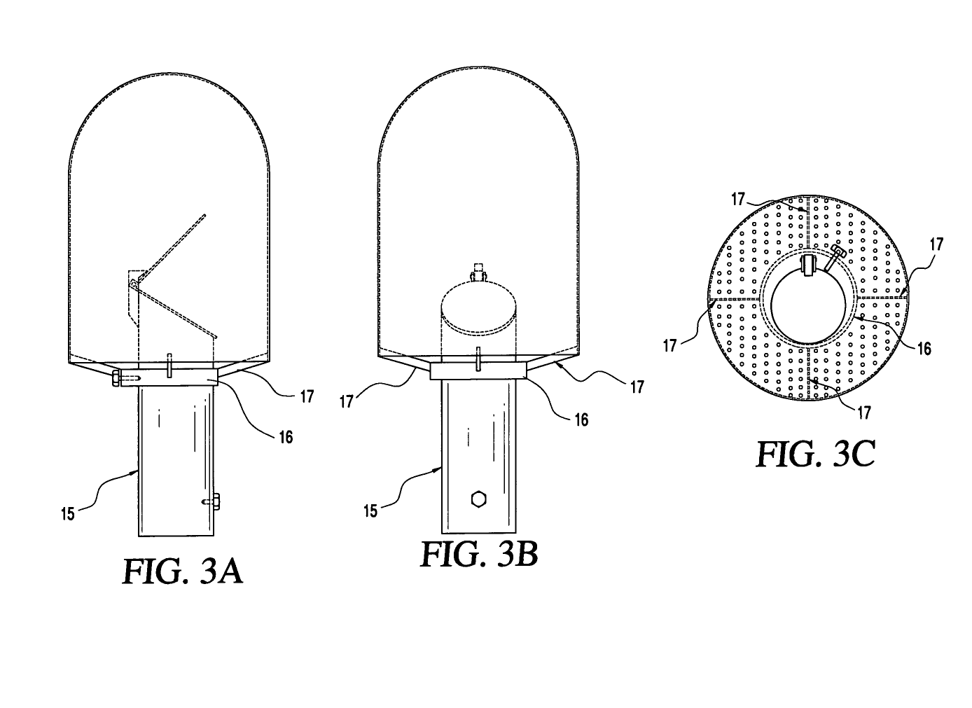

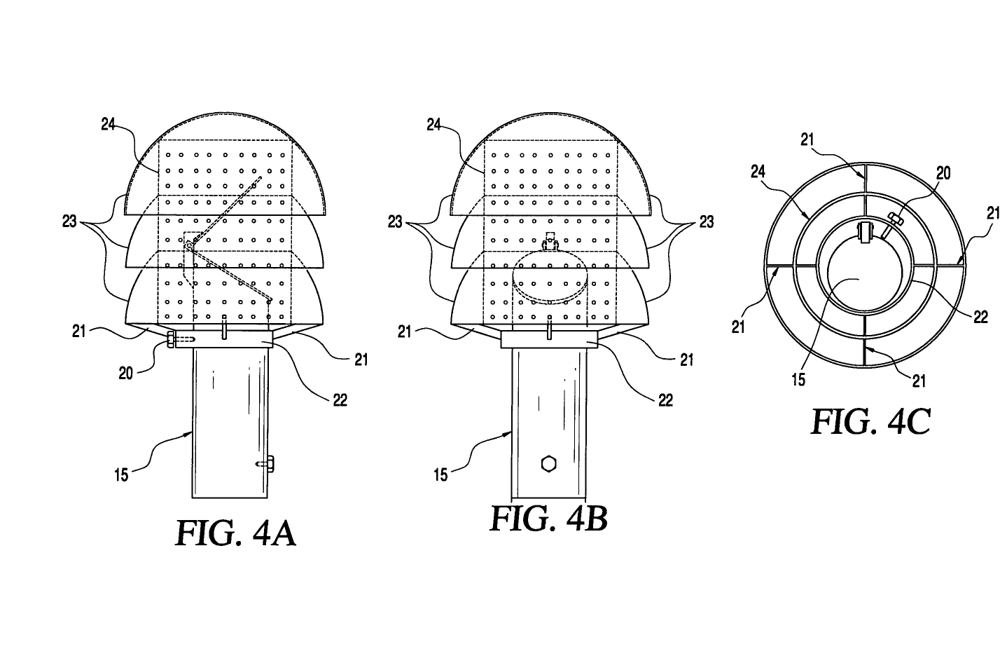

The basic vent protector is rendered more reliably weather proof by equipping it with a hood of the type depicted in FIGS. 3A-3C inclusive or that of FIGS. 4A-4C.

Both types of hood can be used with the basic vent protector of FIGS. 1A-1D inclusive or that of FIGS. 2A-2D inclusive. Here both are shown with the basic vent protector of FIGS. 2A-2D.

The hood in each instance is a relatively large piece, in height and breadth, in relation to both. the vent pipe and the vent protector which jackets the vent pipe. The hood is attached to the upper end of the vent protector pipe by a sleeve from which at least two support arms extend outward to the bottom periphery of the hood itself. The sleeve may be attached to the vent protector by means of one or more set screws or in any other manner that insures a secure, stable connection between the two. Just above. the support arms the hood is equipped with a backplate designed to fit around and completely surround the sleeve that is fitted around the vent protector pipe and to extend out in its outer dimensions so as to fit the bottom of the inner wall of the hood. The backplate may be perforated as shown in FIG. 3C or if the hood is equipped with a drain tube as shown in FIG. 4A, B, and C then the backplate is constructed as shown in FIG. 4C so that the space between the sleeve and the drain tube is unobstructed at the bottom but the space between the drain tube and the inner wall of the hood's lowest tier is covered by a solid, ring-shaped backplate of metal or plastic. The backplate of FIG. 4C, when in place, is impervious to both the outgoing emanations exhausted from the underlying building and substances in the external atmosphere of the nature of those that routinely enter buildings when exhaust vent pipes are uncapped.

With specific reference to FIGS. 3A-3C, a hood is depicted which may be constructed of lightweight, rustproof metal or of an impermeable plastic such as polyvinyl chloride. In this set of figures, the integers 15 denote the outside of a vent protector pipe, intergers 16 refer to the sleeve and integers 17 refer to support arms.

FIG. 3A shows the hooded vent protector pipe enclosed by the hood while the vent protector is in open exhaust mode with its hinged cap open. In FIG. 3B the hinged cap of the vent protector pipe is closed. FIG. 3C shows a view of the backplate as it would appear if one could look down from just above the closed cap of the vent protector tube. In this view the sleeve 16 surrounds the capped vent protector pipe, the support arms 17 just beneath the backplate appear and the perforations in the backplate which permit drainage of exhausted air from the building appear.

FIGS. 4A, B and C show another type of hood arrangement attached to the vent protector—vent pipe assembly of FIGS. 2A-2D inclusive. In this embodiment, the hood is a 3-tiered series of dome-like members which encompass a drain tube that extends around the circumference of the vent protector/vent pipe assembly. As can be seen in FIGS. 4A-C inclusive, the drain tube has small holes over its entire surface through which building effluents exhausted through the vent pipe and vent protector are expelled to the atmosphere. The 3-tiered hood insures that the drain tube is protected from insects, birds and small animals, weather effects such rain, snow sleet and other forms of moisture, wind effects and windblown debris, including dust and dirt, etc. Because the backplate of this hood arrangement consists of a solid ring of metal or plastic, any unwanted exterior moisture or other material that does penetrate past the hood is trapped there and cannot pass into the vent protector top when the cap is in open position.

Turning to FIGS. 4A-4C inclusive, it can be seen that the hood is attached to the vent protector tube 15 with one or more set screws 20 and support arms 21 which are connected to the sleeve 22. Each of the top tiers 23 of the hood is open at the bottom to enable effluents from the building to be expelled through the drain tube 24; the bottom tier 23 is partially closed off by the backplate which is shown in cross section in FIG. 4C. FIG. 4B represents the same arrangement as FIG. 4A from the front perspective with the cap of the vent protector closed. FIG. 4A, as can be seen, shows a side view of the hooded vent protector—vent pipe assembly with the cap of the vent protector in the open position that is automatically created by the pressure that exhausts airborne odors and other effluents from a building,

FIG. 4C shows the backplate employed with the type of hood plus drain tube arrangement of FIGS. 4A and 4B. As can be seen in this figure, the circular shaped drain tube has a circumference substantially greater than that of the vent protector pipe, and the backplate is in the form of a solid ring of rustproof metal or plastic.

As has been noted above, the embodiments of vent protector and hooded vent protector specifically exemplified herein have been devised with particular reference to protecting the vent pipes that presently are in place on existing buildings. In devising vent-protected arrangements for buildings not yet completed or still to be built, it is not only contemplated that units wherein vent pipes of the type now in use may be matched with vent protector units featuring pipe of larger circumference with both units reciprocally threaded to enable them to be screwed together, but it is envisioned that unitary vent pipes extended in length to a moderate degree over those presently in use may be equipped with hinged cap arrangements of either type herein disclosed and depicted and that preferably the tops of such pipes will be fashioned to allow the capping of the arrangement to take place in a slightly downwardly inclined direction, of the order of about 15-20 degrees from horizontal with the cap slightly overlapping the rim of the pipe when in closed position.

It is further envisioned that the shapes of the hoods depicted herein could be modified; for example, either or both versions could easily be adapted to have a generally conical rather than a generally rounded shape.

Because it is apparent that many modifications of the invention herein disclosed can readily be made without departing from the invention, it is intended that the scope of the invention be limited only by the appended claims.

I claim:

1. A device for protecting an external open vent pipe of a building wherein said vent pipe is connected to an exhaust means within the building which, when activated, exhausts from the building smoke, fumes, unpleasant odors and other unwanted airborne substances, which device comprises a length of pipe equipped at its top end with a hinged cap and stably connected at its bottom end to the vent pipe, whereby the pressure of air being expelled through said vent pipe as a result of the activation of said exhaust means causes said hinged cap to open and remain open until the expulsion of air through said vent pipe ceases, whereupon said hinged cap closes to form a cover over the pipe assembly and prevents the ingress into said building through said vent pipe of foreign substances present in the external atmospheric air including insects, weather-derived moisture, dust, dirt, and various contaminants, until such time as said exhaust means is again reactivated.

2. A device according to claim 1 in which said device comprises a length of pipe having a slightly larger circumference than said open vent pipe whereby said length of pipe fits over and partially jackets said vent pipe at its open end.

3. A device according to claim 2 in which said device is stably connected to said open vent pipe by means of at least one set screw which is caused to penetrate a wall of both said lengths of pipe having a slightly larger circumference than said vent pipe and the adjacent wall of said vent pipe, providing a stable connection between them.

4. A device according to claim 1 wherein said length of pipe is equipped at its top end with a hinged cap and, prior to application of said cap to said top end has been cut or machined so that its open top periphery has a downwardly slanted face and said hinged cap is attached to said top end of said length of pipe so that its appended hinge rests at the highest portion of the downwardly slanted face of said top end.

5. A device according to claim 1 wherein the hinged cap of said length of pipe has a circular shape which is bisected along a diameter by its hinge whereby pressure of expelled gas causes both halves of said cap to open, and said length of pipe, prior to application of said hinged cap to its top end, has been cut or machined so that its highest points are diametrically aligned opposite one another along its top and the balance of the top periphery of said length of pipe has been made from about 15 to 20 angular degrees lower than said highest points, and said hinge is connected to said highest points of said top periphery and its respective cap portions extend downwardly over said lower portions of said top periphery when said cap portions are in closed relationship to said length of pipe.

6. A device according to claim 1 wherein the outer edges of the cap portion of said hinged cap overhang the top rim of said length of pipe slightly when said cap is in closed relationship to said length of pipe.

7. A device according to claim 1 which is equipped with a hood that is connected thereto near the top of said length of pipe but below the location of its hinged cap by a sleeve which may optionally be attached through one or more set screws and by up to four support arms extending outwardly from said sleeve to the bottom part of the inner wall of said hood whereby the interior of said device and the interior of the vent pipe to which it is stably connected are rendered resistant to insects, rain, snow, and other moisture.

8. A device according to claim 7 in which said hood comprises a (i) generally elongated chamber of circular cross section having a substantially larger circumference and substantially greater height than said device, (ii) is equipped with a backflow plate which fits around said sleeve and extends outwardly therefrom in all directions to the inner wall of said hood and is characterized by the presence of many essentially evenly spaced perforations over its entire area through which effluents expelled from said vent pipe passes into the outside atmosphere.

9. A device according to claim 7 in which said hood comprises (a) an assembly of three generally dome-shaped layers of weather-resistant plastic or metal stacked in series above one another which together enclose (b) a circular cross section drain tube which surrounds the upper portion of said device and extends substantially above the top thereof, which drain tube is further characterized by the presence of many essentially evenly spaced perforations extending over its entire surface through which effluents expelled from said vent pipe pass into the atmosphere, which drain tube is of substantially lesser circumference than the outer hood member in which it is enclosed but of substantially greater circumference than said vent pipe, and (c) wherein the lowest layer of said hood is sealed at its bottom end by a metal plate which extends from the outer periphery of the drain tube to said hood's own inner wall in all directions

10. A device for venting from a building air carrying smoke, fumes or odors which is connected to an exhaust means)within said building which, when activated, exhausts from within said building at a selected location thereof, air carrying smoke, fumes or odors into
a) a vent pipe which at its upper end is stably connected by any means capable of achieving a stable connection, to
b) a length of pipe equipped at its uppermost end with
c) a hinged cover which hinged cover (i) is opened by the pressure exerted by said exhaust means as it exhausts said air carrying smokes, fumes, or odors and (ii) when so opened expels said air sequentially into vent pipe (a) and length of pipe (b), to the exterior atmosphere, and (iii) when said pressure ceases, said cap closes thereby preventing ingress into the building of dust, dirt, insects, moisture, allergens, pathogens, and other materials contained in the external air.

11. A device according to claim 10 that is made essentially weatherproof by further superimposing, via stable connecting means, over the upper portion of part (b) including its hinged cover, a hood member which extends substantially higher and is of substantially greater breadth dimensions in all directions than part (b).

12. A device according to claim 10 wherein parts (a) and (b) thereof are subsumed into one continuous pipe length surmounted by a hinged cover.

13. A device according to claim 12 that is made essentially weatherproof by further superimposing over the upper portion thereof, via stable connecting means a hood member which extends substantially higher and is of substantially greater breadth dimensions in all directions than said device itself.
